(19) United States
(12) Patent Application Publication
(10) Pub. No.: US 2016/0195247 A1
(43) Pub. Date: Jul. 7, 2016

(54) LED ILLUMINATION MODULE

(71) Applicant: ZUMTOBEL LIGHTING GMBH, Dornbirn (AT)

(72) Inventors: Wolfgang BECHTER, Hittisau (AT); Wolfgang RUEF, Dornbirn (AT); Joachim FRICK, Klaus (AT)

(21) Appl. No.: 14/905,643

(22) PCT Filed: Jul. 23, 2014
(86) PCT No.: PCT/EP2014/065796

§ 371 Date: Jan. 15, 2016

(30) Foreign Application Priority Data
Jul. 23, 2013 (DE) 20 2013 103 294.8

(51) Int. Cl. F21V 17/16; F21V 19/00; F21V 3/02

(52) U.S. Cl. CPC F21V 17/164; F21V 3/02; F21V 19/004; F21Y 2101/02

(57) ABSTRACT

An illumination module having a LED-circuit for producing a light and a light impermeable cover which is arranged in such a manner that the light at least partially penetrates the cover. The cover is arranged on the LED circuit such that it can be maintained by a locking connection.

The invention relates to an illumination module having an LED circuit board (LED: light-emitting diode) for generating a light, and having a translucent cover.

The designation “illumination module” is to be understood here to mean a light-emitting unit, which has a light source for generating the light, and which is designed to be mechanically attached to a carrier element of a luminaire device for the purpose of operation and to be electrically connected to the carrier element for the purpose of supplying electricity to the light source. The configuration in this case is such that this unit, or the illumination module, can also be reversibly removed again from the carrier element by simple manipulation, for example in order to exchange it for another illumination module. Here, the designation “light module” may also be used synonymously with the term “illumination module”.

Known from the prior art is an illumination module whose light source is constituted by an LED circuit board, the connection between the LED circuit board and the cover being of a comparatively elaborate design, with use of a cooling plate.

The invention is based on the object of specifying an improved illumination module that is distinguished, in particular, by a simplified structure, with particularly good optical properties.

This object is achieved according to the invention with the subject matter stated in the independent claim. Particular embodiment types of the invention are specified in the dependent claims.

Provided according to the invention is an illumination module, which has an LED circuit board for generating a light, and which has a translucent cover, which is arranged in such a manner that the light at least partially goes through the cover. The cover in this case is arranged on the LED circuit board such that it is held only by means of a latching connection.

The structure of the illumination module is thereby simplified significantly; it is possible to dispense with a cooling plate. The LED circuit board can serve directly as a carrier for the cover. In comparison with the prior art, therefore, the number of elements, or components, of which the illumination module is composed can be reduced. Furthermore, tolerance-related deviations from reference dimensions, in respect of the LED circuit board and the cover, can thereby be kept smaller; in this way, the relative arrangement between, on the one hand, the LED circuit board serving as a light source, and, on the other hand, an optical element for influencing the light generated by the LED circuit board, can be defined in a particularly exact manner, such that, consequently, the optical effect of the optical element can also be determined in a particularly precise manner.

Preferably, the cover is designed in the shape of a pot, such that it has a base region and a side-wall region, the latching connection being designed so as to act on the side-wall region. This design enables an interior of the illumination module to be formed, or delimited, solely by the LED circuit board, on the one hand, and the cover, on the other hand. At least one LED of the LED circuit board can be arranged in a well-protected manner in this interior. Furthermore, preferably, in this case the base region of the cover constitutes a light-radiating face of the illumination module, in such a manner that the light exits the illumination module through it, at least partially.

Preferably, the LED circuit board has a stepping at the edge. This stepping may serve, advantageously, as a working face for the latching connection. Preferably in this case, the stepping of the LED circuit board is realized in the form of a continuous, closed ring at the edge. The stepping also has the effect, in particular, that latching elements that are realized on the cover do not project over the level of a surface of the LED circuit board that is opposite to the at least one LED. As a result, the illumination module can be arranged so as to contact a planar face in a particularly suitable manner in respect of a transfer of heat.

The stepping in this case is produced by a milling process, which is advantageous in respect of production engineering.

Preferably, the LED circuit board has a thickness of more than 1 mm in a middle region. It is thus particularly suitable as a stable carrier element of the cover. If the

LED circuit board is constituted by a metal-core circuit board, it has particularly good thermal conduction properties. This is advantageous in respect of the removal of heat formed by the at least one LED of the LED circuit board during operation of the illumination module.

Preferably, the latching connection has latching elements, which are realized on the cover, the latching elements being arranged so as to engage behind the LED circuit board. This enables the cover to be held on the LED circuit board in a suitable, stable manner. Preferably, the latching elements are realized in the form of catches, or projections. This assists ease of handling in the assembly of the illumination module.

Preferably, the illumination module is designed in such a manner that the latching elements are arranged so as to engage behind the LED circuit board in such a manner that they are arranged so as to contact only the stepping. In particular, the configuration may be such that the LED circuit board has a delimiting face, by which an outer face of the illumination module is constituted, the cover being arranged in such a manner that it does not go through a plane defined by the delimiting face. It can thereby be achieved, in a particularly suitable manner, that the latching elements do not project over that surface of the LED circuit board that is opposite the at least one LED.

In particular, in this case the cover may have a delimiting face, in such a manner that the delimiting face of the LED circuit board and the delimiting face of the cover lie in the said plane. This has the effect that the LED circuit board does not appear directly visible to a viewer of the illumination module if the viewer glances at the cover.

Preferably, the illumination module furthermore has an optical element for influencing the light, which is preferably arranged in such a manner that the LED circuit board is arranged so as to be supported on the optical element. This has the effect that the relative position between the optical element and the LED circuit board can be defined in a particularly precise manner. The optical effect of the optical element can thus be determined in a particularly exact manner.

Preferably, the illumination module in this case is designed in such a manner that the optical element is arranged within a region enclosed by the side-wall region. This enables the illumination module to be of a particularly compact design.

The invention is explained in greater detail in the following on the basis of an exemplary embodiment and with reference to the drawings. There are shown in:

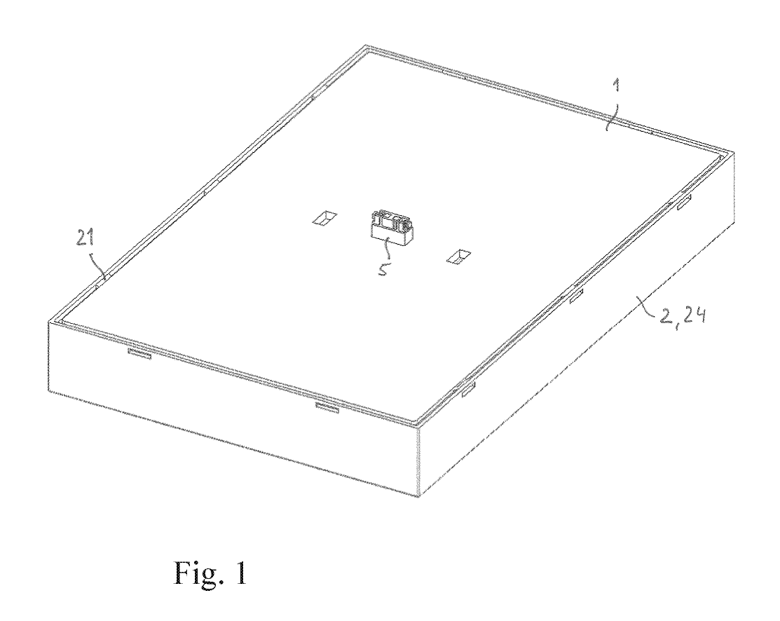

FIG. 1 a sketch of an illumination module according to the invention,

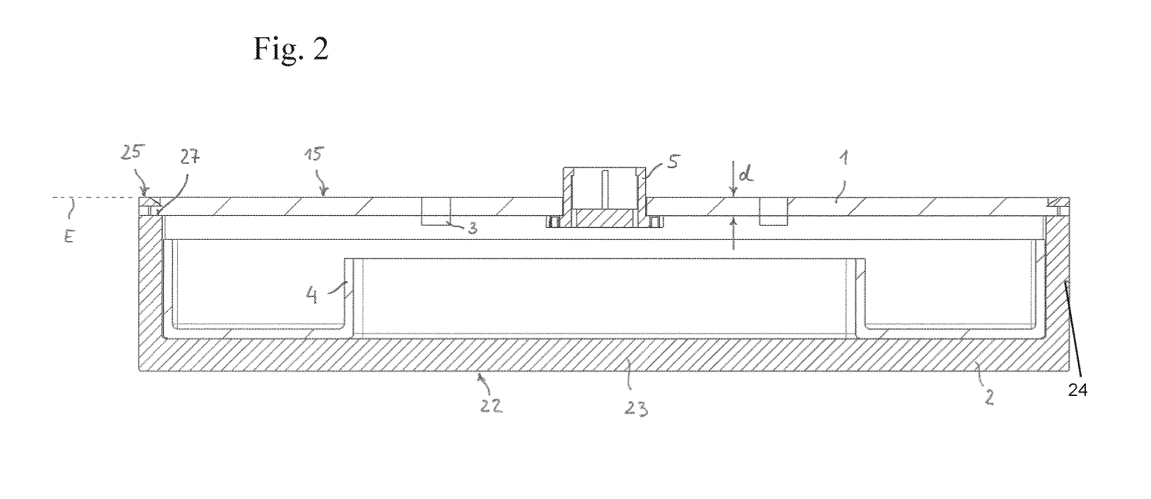

FIG. 2 a cross section through the illumination module,

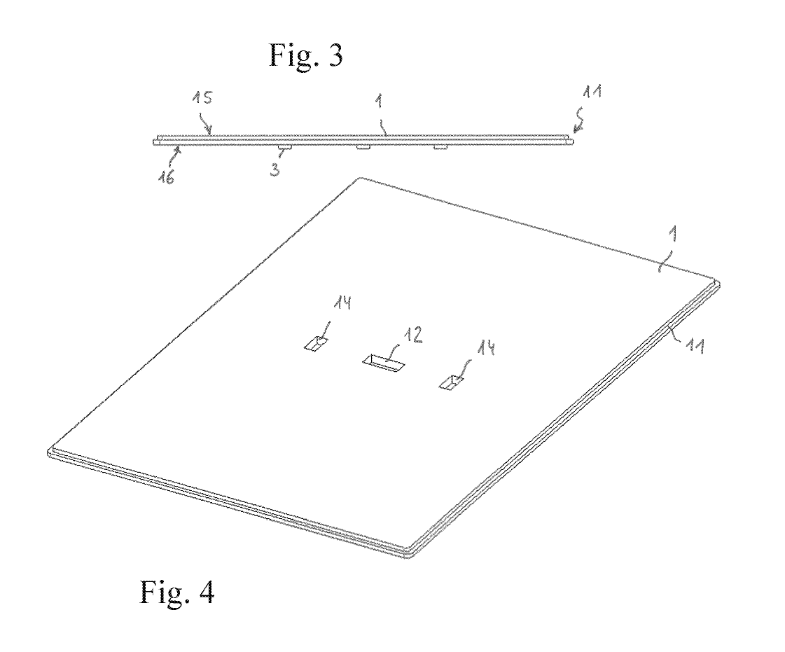

FIG. 3 a cross section through the separated LED circuit board of the illumination module, and

FIG. 4 a perspective sketch of the separated LED circuit board.

FIG. 1 shows a perspective sketch of an illumination module according to the invention. The illumination module has an LED circuit board 1, and a translucent cover 2. The cover 2 may be composed, for example, of plastic.

The LED circuit board 1 is sketched in separated form in the cross section in FIG. 3. For the purpose of generating a light, the LED circuit board 1 has, in particular, at least one LED 3. The expression “LED circuit board” is intended here to designate the corresponding circuit board with the at least one LED 3 arranged thereon. The separated LED circuit board 1 is shown in a perspective sketch in FIG. 4.

The illumination module is designed to be mechanically attached to a carrier element (not shown in the figures) of a luminaire device for the purpose of operation and to be electrically connected to this carrier element for the purpose of supplying electricity to the at least one LED. For this electrical connection, the illumination module may have, in particular, a plug connector 5.

The LED circuit board 1 is preferably in the form of a plate, and has a surface, or delimiting face 15, and a further delimiting face 16, which is parallel thereto, the at least one LED 3 being arranged on the further delimiting face 16, in particular only on the further delimiting face 16.

The delimiting face 15 is preferably of planar design. The delimiting face 15 may be provided to flatly contact a likewise planar bearing region of the carrier element of the luminaire device, when the illumination module is, or has been, mechanically attached to the carrier element of the luminaire device for the purpose of operation.

In the case of the exemplary embodiment, the plug connector 5 projects beyond the delimiting face 15, an accordingly corresponding socket being realized on the carrier element of the luminaire device. For the purpose of accommodating the plug connector 5, the LED circuit board 1 may have a corresponding lead-through opening 12.

FIG. 2 shows a cross section through the illumination module. The illumination module is designed in such a manner, or the cover 2 is arranged in such a manner, that the light generated by the LED circuit board 1 at least partially, in particular at least predominantly, goes through the cover 2.

Preferably, the cover 2 is designed in the shape of a pot, such that it has a base region 23 and a side-wall region 24. In particular, the cover 2—as shown exemplarily by the figures—may be shaped, at least in a first approximation, such that it defines a rectangular parallelepiped shape, the base region 23 describing a first rectangular face of the rectangular parallelepiped, and the side-wall region 24 describing four further rectangular faces of the rectangular parallelepiped, which adjoin that rectangular face that is described by the base region 23.

The side-wall region 24 may thus be designed, in particular, so as to be continuous, the LED circuit board 1 being arranged in the region of the opening formed thus by the side-wall region 24, in particular being arranged so as to cover this opening. Accordingly, the base region 23 of the cover 2 may be designed so as to be approximately as large as the LED circuit board 1.

In the case of the exemplary embodiment, the base region 23 of the cover 2 constitutes a light-radiating face 22 of the illumination module, in such a manner that the light that is generated by the LED circuit board 1 exits the illumination module through it, at least partially. The light-radiating face 22 may be planar in form; in particular, the illumination module may be designed such that the light-radiating face 22 is oriented parallel to the delimiting face 15 of the LED circuit board 1.

The cover 2 is disposed on the LED circuit board 1 such that it is held only by means of a latching connection. This is advantageous, because it is thus possible to dispense with a separate component serving to hold the LED circuit board 1, or to hold the cover 2. In particular, the illumination module is designed in such a manner that the latching connection acts directly between the LED circuit board 1, on the one hand, and the cover 2, on the other hand, thus without the involvement of a further component.

In the case of the exemplary embodiment, the illumination module is designed such that both the LED circuit board 1 and the cover 2 constitute outer faces of the illumination module. In particular, the delimiting face 15 of the LED circuit board 1 constitutes an outer face of the illumination module.

Preferably, the latching connection has latching elements 21, which are realized on the cover 2, the latching elements 21 being arranged so as to engage behind the LED circuit board 1. Preferably, the latching elements 21 are realized on the side-wall region 24 of the cover 2.

Preferably, the latching elements 21 are realized in the form of catches, or projections. This allows the cover 2 to be assembled together with the LED circuit board 1 particularly easily.

The latching connection may be designed in such a manner that it can no longer be opened without being destroyed.

As is the case in the exemplary embodiment and as can be seen, for example, from FIG. 2, the cover 2 may have a seating shoulder 27, in particular realized in the form of a continuous ring on the side-wall region 24, which seating shoulder serves to seat the LED circuit board 1 and which, by acting in combination with the latching elements 21, holds the cover 2 in position relative to the LED circuit board 1. For the purpose of assembly, it may accordingly be provided that the LED circuit board 1 is inserted in the opening formed by the side-wall region 24 of the cover 2, until it contacts the seating shoulder 27 all the way round at the edge and the latching elements 21 grip around, or engage behind, the LED circuit board 1 by latching.

Preferably, the LED circuit board 1—measured without the at least one LED 3—is a thick circuit board, such that it has a stability particularly suited to holding the cover 2. In particular, the LED circuit board 1—measured without the at least one LED 3—may have a thickness d of more than 1 mm in a middle region. Preferably, the LED circuit board 1 is designed to serve as a carrier of the entire illumination module.

Furthermore, preferably, the LED circuit board 1 is constituted by a metal-core circuit board, for example an aluminum metal-core circuit board. This makes it possible, in particular, for heat generated by the at least one LED 3 of the LED circuit board 1 during operation of the illumination module to be transmitted onto the delimiting face 15 of the LED circuit board 1, and consequently onto an outer face, or surface, of the illumination module. The LED circuit board 1 can thus constitute, as it were, a heat sink of the illumination module.

As is the case in the exemplary embodiment, the LED circuit board 1 preferably has a stepping 11 at the edge, or at its circumferential region. In particular, the stepping 11 of the LED circuit board 1 may be realized in the form of a continuous, closed ring at the edge, as indicated exemplarily in FIG. 4. In this case, the corner regions of the LED circuit board 1, including the stepping 11, are preferably rounded.

As can be seen, for example, from FIG. 3, the stepping 11 is realized, in particular, on that side of the LED circuit board 1 that is opposite to the at least one LED 3. The stepping 11 thus directly adjoins the delimiting face 15 of the LED circuit board 1.

The stepping 11 constitutes a working face that is particularly well suited to the latching connection. In particular, the stepping 11 makes it possible—as can be seen from FIG. 2—for the cover 2 not to extend beyond a plane E that is defined by the delimiting face 15 of the LED circuit board 1. In the case of the exemplary embodiment, the configuration is such that the latching elements 21 are arranged so as to contact only the stepping 11. This enables the illumination module to be mechanically attached to the carrier element of the luminaire device, for the purpose of operation, in such a manner that the delimiting face 15 of the LED circuit board 1 flatly contacts a planar surface region of this carrier element, and a particularly suitable removal of heat is thus achieved.

As indicated in FIG. 2, in the case of the exemplary embodiment the configuration is furthermore such that the cover 2 has a delimiting face 25, in such a manner that the delimiting face 15 of the LED circuit board 1 and the delimiting face 25 of the cover 5 lie in the plane E. The delimiting face 25 of the cover 2 may be constituted, in particular, by an edge region of the cover 2 constituted by the side-wall region 24. In other words, it may thus be provided that the delimiting face 15 of the LED circuit board 1, which may be understood as a “back side” of the LED circuit board 1, closes in a flush manner with this edge region of the cover 2.

It can thus be achieved that a viewer of the illumination module—if the latter is arranged with the delimiting face 15 contacting the carrier element of the luminaire device—does not look directly at the LED circuit board 1 when viewing the illumination module.

For the purpose of producing an LED circuit board, it is known from the prior art to score and then to break the circuit board material. In contrast to this, it is preferably provided, for the purpose of producing the LED circuit board 1 of the illumination module described here, to produce the stepping 11 by a milling process, in particular by means of a step milling cutter.

Furthermore, preferably, the illumination module additionally has an optical element 4, for influencing the light. The optical element 4 in this case may be arranged in such a manner that the LED circuit board 1 is arranged so as to be supported on the optical element 4. A provided relative arrangement between the LED circuit board 1 and the optical element 4 can thereby be maintained in a particularly exact manner.

The optical element 4 may be realized, for example, to alter the directional behavior of the light that is generated by the LED circuit board 4. Accordingly, the optical element 4 may be arranged between the LED circuit board 1, on the one hand, and the base region 23 of the cover 2, on the other hand.

For example, the optical element 4 may have a lens element, for example in the form of a lens cluster, by which at least a portion of the light is influenced; alternatively or additionally, the optical element 4 may have an optically scattering element, by which at least a portion of the light, or possibly a further portion of the light, is influenced.

As is the case in the exemplary embodiment, the optical element 4 may be arranged in the interior of the illumination module that is formed, on the one hand, by the LED circuit board 1, and on the other hand by the pot-shaped cover 2. In particular, the configuration may be such that the optical element 4 is arranged within a region enclosed by the side-wall region 24 of the cover 2.

Owing to the overall small number of components and the therewith associated small tolerances, it is possible for the at least one LED 3 of the LED circuit board 1 to be arranged in a particularly precise manner relative to the optical element 4 and relative to the cover 2.

In the case of the exemplary embodiment, the optical element 4 is arranged such that it is inserted in the pot-shaped cover 2.

In the case of the exemplary embodiment, the LED circuit board 1 also additionally has at least one recess 14, which is designed as a working point for a holding element for mechanically holding the illumination module on the carrier element of the luminaire device. Apart from the lead-through opening 12 for the plug connector 5 and the at least one recess 14, the LED circuit board 1 does not have any indentation.

1. An illumination module comprising:
an LED circuit board for generating a light, and
a translucent cover, which is arranged in such a manner that the light at least partially goes through the cover, wherein the cover is arranged on the LED circuit board such that it is held only by a latching connection.

2. The illumination module as claimed in claim 1, wherein the cover is designed in the shape of a pot, such that it has a base region and a side-wall region, the latching connection being designed so as to act on the side-wall region.

3. The illumination module as claimed in claim 2, wherein the base region of the cover constitutes a light-radiating face of the illumination module, in such a manner that the light exits the illumination module through it, at least partially.

4. The illumination module as claimed in claim 1, wherein the LED circuit board has a stepping at the edge.

5. The illumination module as claimed in claim 4, wherein the stepping of the LED circuit board is realized in the form of a continuous, closed ring at the edge.

6. The illumination module as claimed in claim 4, wherein the stepping is produced by a milling process.

7. The illumination module as claimed in claim 1, wherein the LED circuit board has a thickness (d) of more than 1 mm in a middle region.

8. The illumination module as claimed in claim 1, wherein the LED circuit board is constituted by a metal-core circuit board.

9. The illumination module as claimed in claim 1, wherein the latching connection has latching elements, which are realized on the cover, the latching elements being arranged so as to engage behind the LED circuit board.

10. The illumination module as claimed in claim 9, wherein the latching elements are realized in the form of catches, or projections.

11. The illumination module as claimed in claim 4, wherein the latching elements are arranged so as to engage behind the LED circuit board in such a manner that they are arranged so as to contact only the stepping.

12. The illumination module as claimed in claim 11, wherein the LED circuit board has a delimiting face, by which an outer face of the illumination module is constituted, the cover being arranged in such a manner that it does not go through a plane (E) defined by the delimiting face.

13. The illumination module as claimed in claim 12, wherein the cover has a delimiting face, in such a manner that the delimiting face of the LED circuit board and the delimiting face of the cover lie in the plane (E).

14. The illumination module as claimed in claim 1, further comprising:
an optical element for influencing the light, which is preferably arranged in such a manner that the LED circuit board is arranged so as to be supported on the optical element.

15. The illumination module as claimed in claim 2, which is designed in such a manner that the optical element is arranged within a region enclosed by the side-wall region.
